(19) United States
(12) Patent Application Publication
(10) Pub. No.: US 2008/0171889 A1
(43) Pub. Date: Jul. 17, 2008

(54) METHOD OF INCREASING TRANSESTERIFICATION OF OILS

(75) Inventors: Yi-Hung CHEN, Kaohsiung City (TW); Ching-Yuan CHANG, Kaohsiung City (TW); Yu-Hang HUANG, Kaohsiung City (TW); Rong-Hsien LIN, Kaohsiung City (TW)

Correspondence Address: PATENTTM.US, P. O. BOX 82788, PORTLAND, OR, 97282-0788, US

(73) Assignee: NATIONAL KAOHSIUNH UNIVERSITY OF APPLIED SCIENCES, Kaohsiung City (TW)

(21) Appl. No.: 12/014,052

(22) Filed: Jan. 14, 2008

(30) Foreign Application Priority Data
Jan. 16, 2007 (TW) 096101530

(51) Int. Cl. C11B 7/00

(52) U.S. Cl. 554/174

(57) ABSTRACT

A method of increasing transesterification conversion of oils includes steps of packing a filler into a rotating packed bed reactor having a rotary bed, centrifugally rotating the rotary bed, injecting an oil into the rotary bed, performing transesterification with adding a reaction gas into the rotating packed bed reactor and collecting the modified oil. By centrifugally rotating the rotary bed, the oil is provided with kinetic energy to pass through the filler and transesterification conversion of the oil is raised. Therefore, manufacturing costs can be lowered and the oil is modified to become suitable fuel for automobiles or motorcycles.

### BACKGROUND OF THE INVENTION

1. Field of Invention

The present invention relates to biodiesel, and more particularly to a method of increasing transesterification conversion of oils by using a rotating packed bed reactor.

2. Description of the Related Art

Because of increasing growth of industry, transport and commerce, petroleum consumption is steadily rising. However, due to limited petroleum reserves, petroleum price is also increasing and many studies are conducted regarding alternative fuels. Biodiesel is one alternative fuels that are considered to replace petroleum fuel.

Biodiesel is converted from edible oils such as vegetable oil and animal fat by alcoholysis to form modified oils that can be used as renewable fuel. Because the edible oils are derived from carbon dioxide in the atmosphere via photosynthesis mechanism of plants, the gases discharged from the burning of biodiesel make nearly null increase in the greenhouse effect. However, petroleum fuels are drawn from carbon stores in the earth's crust and used accompanying the release of carbon dioxide to the atmosphere. Therefore, biodiesel is also beneficial for environmental protection.

Because of high viscosity of edible oils (27.2˜53.6 mm²/s at 38° C.), edible oils are not suitable to be used directly as fuel oils for vehicles and usually can undergo transesterification process to reduce viscosity. A conventional transesterification process uses a mechanical agitating device to mix edible oils in batch type operation with additives for modification of g edible oils. However, conventional transesterification process takes a long period of time due to immiscibility of oils and additives while transesterification conversion of edible oils may not be sufficient. Hence, manufacturing costs of oil modification increase and the productivity of biodiesel is limited.

Many researchers are engaged in studies of modifying edible oils recently. Noureddini et al. (1988) investigated alkaline transesterification reaction of soybean oil with methanol at various operation conditions. Ma et al. (1999) suggested that droplet diameter (solution of NaOH-MeOH) was inversely proportional to the square of the rotating speed in a stirring reactor. Harvey et al. (2003) performed a transesterification reaction of rapeseed oil with a continuous oscillatory flow reactor to improve mixing at a lower residence time. Noureddini et al. (2004) found that reaction temperature had a greater influence on transesterification reaction rate than mixing at a high temperature (200° C.˜240° C.).

However, above researches did not provide practical method about improving transesterification conversion of edible oils. Thus modifying edible oils aims at how to increase transesterification conversion and reduce reaction time so as to lower a manufacturing cost of biodiesel. To overcome the shortcomings, the present invention provides a method of increasing transesterification conversion of oils to mitigate or obviate the aforementioned problems.

### SUMMARY OF THE INVENTION

The primary objective of the present invention is to provide a method of increasing transesterification conversion of oils with a rotating packed bed reactor to reduce reaction time.

A method of increasing transesterification conversion of oils in accordance with the present invention comprises steps of:

packing a filler: the filler is packed into a rotating packed bed reactor. The rotating packed bed reactor comprises a container and a rotary bed. The container has an upper side, a lower side, a peripheral wall, an oil feed, a gas inlet and an oil outlet. The oil feed is formed in the upper side of container. The gas inlet is formed in the peripheral wall of the container. The oil outlet is formed in the lower side of the container. The rotary bed rotatably mounted in the container has an inner wall allowing passage of oils and a packed reaction region formed along the radial direction of the rotary bed for packing the filler;

centrifugally rotating: the rotary bed is driven to rotate relative to the container by a rotary driver.

injecting an oil: the oil and an additive are injected into the rotary bed through the oil feed.

transesterification: the centrifugal rotating of the rotary bed forces the oil and additive to pass through the filler in the packed reaction region to perform transesterification reaction.
collecting: the oil and additive pass through the filler in the packed reaction region and then are collected at the oil outlet.

The oil may be animal oil, vegetable oil, organic acid or a mixture thereof.

The animal oil and the vegetable oil may be a substance having triglyceride.

The substance having triglyceride may be selected from the group consisting of tung oil, peanut oil, cottonseed oil, rapeseed oil, Chinese tallow tree seed oil, tea oil, soybean oil, sesame oil, ricinus oil, corn oil, rice bran oil, palm oil, coconut oil, kardiseed oil, beef tallow oil, lard oil and sunflower oil.

The organic acid may comprise a hydrocarbon having carboxyl group.

The hydrocarbon having carboxyl group may be oleic acid.

The filler may be stainless steel, alkaline-earth metal compound, alumina, resin, zeolites, silicone or active carbon.

The additive may be alcohol, alkali metal compound, lipase or inorganic acid.

The alkali metal compound is sodium hydroxide (NaOH), potassium hydroxide (KOH) or sodium methoxide (CH₃ONa).

The inorganic acid may be sulfuric acid, nitric acid or phosphoric acid.

The alcohol may be methanol, ethanol, propanol, isopropanol or butanol.

The reaction gas may be ozone.

By means of the centrifugal rotating of the rotary bed, the oil and the additive are provided with kinetic energy to pass through the filler. The transesterification conversion of the oil is promoted by applying the present invention. Test results have shown that transesterification conversion of the oil in accordance with the present invention is higher and more efficient than that with a conventional method. Therefore, manufacturing costs can be lowered by employing the present invention.

Other objectives, advantages and novel features of the present invention will become more apparent from the following detailed description when taken in conjunction with the accompanying drawings.

### BRIEF DESCRIPTION OF THE DRAWINGS

FIG. 1 is a schematic diagram of a method of increasing transesterification conversion of oils in accordance with the present invention; and

FIG. 2 is schematic side view in partial cross-section of a rotating packed bed reactor.

### DETAILED DESCRIPTION OF THE INVENTION

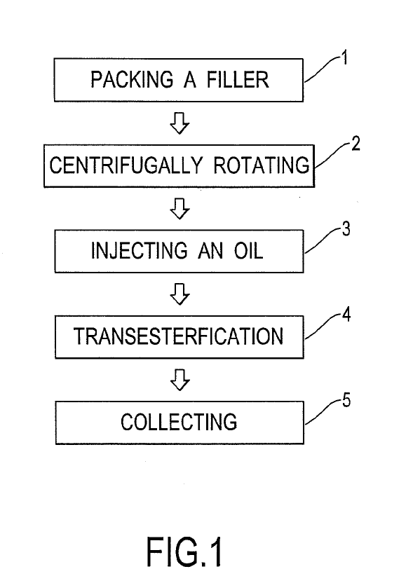

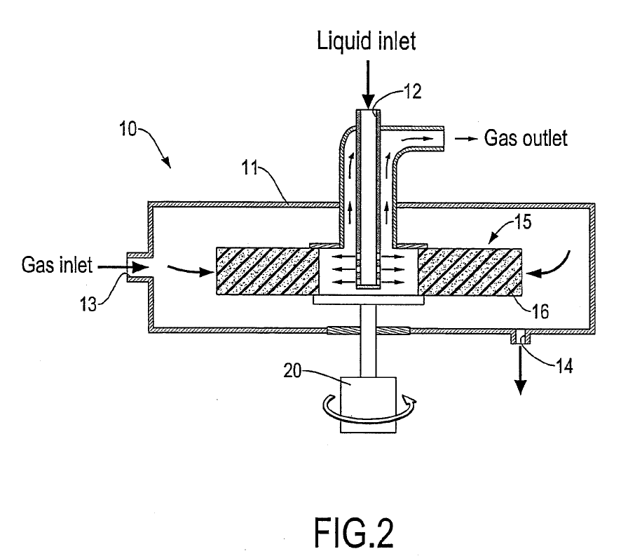

With reference to FIGS. 1 and 2, a method of increasing transesterification conversion of oils in accordance with the present invention comprises steps of packing a filler, centrifugally rotating, injecting an oil, transesterification and collecting.

In the step of packing a filler (1), the filler is packed into a rotating packed bed reactor (10). The rotating packed bed reactor (10) comprises a container (11) and a rotary bed (15). The container (11) has an upper side, a lower side, a peripheral wall, an oil feed (12), a gas inlet (13) and an oil outlet (14). The oil feed (12) is formed centrally in the upper side of the container (11). The gas inlet (13) is formed in the peripheral wall of the container (11). The oil outlet (14) is formed in the lower side of the container (11). The rotary bed (15) with an inner wall and a packed reaction region (16) is powered to rotate and rotatably mounted in the container (11). The inner wall allows passage of oils. The packed reaction region (16) is formed along the radial direction of the rotary bed (15) and packed with the filler.

In the step of centrifugally rotating (2), the rotary bed (15) is driven to rotate relative to the container (11) by a rotary driver (20), which is mounted under the rotating packed bed reactor (10) and having a drive shaft mounted through the container (11) to connect with the rotary bed (15).

In the step of injecting an oil (3), the oil and an additive are injected into the rotary bed (15) through the oil feed (12).

In the step of transesterification (4), a reaction gas may be added to the rotating packed bed reactor (10) through the gas inlet (13). Centrifugal rotating of the rotary bed (15) forces the oil and additive to pass through the filler in the packed reaction region (16) and react with the reaction gas to undergo a transesterification reaction.

In the step of collecting (5), the oil and additive pass through the inner wall of rotary bed (15) and then are collected at the oil outlet (14).

### EXAMPLES

A soybean oil was modified in accordance with the present invention to perform a test of transesterification conversion. The additive comprises methanol and an alkali metal compound. The filler is stainless steel wire. Test conditions and results are shown in Table 1.

TABLE 1
Test conditions and results

| | Example | | | | |
|---|---|---|---|---|---|
| | 1 | 2 | 3 | 4 | 5 |
| Oil | Soybean | Soybean | Soybean | Soybean | Soybean |
| | oil | oil | oil | oil | oil |
| Oil flow rate | 180 | 180 | 180 | 180 | 180 |
| (ml/min) | | | | | |
| Methanol | 46 | 46 | 46 | 46 | 46 |
| flow | | | | | |
| rate(ml/min) | | | | | |
| Alkali metal | KOH | KOH | KOH | KOH | KOH |
| compound | | | | | |
| Alkali metal | 1.63 | 1.63 | 1.63 | 1.63 | 1.63 |
| compound | | | | | |
| input | | | | | |
| rate (g/min) | | | | | |
| Filler | Stainless | Stainless | Stainless | Stainless | Stainless |
| | steel wire | steel wire | steel wire | steel wire | steel wire |
| Rotating | 300 | 900 | 1500 | 900 | 900 |
| speed (rpm) | | | | | |
| Reaction | 58 | 58 | 58 | 40 | 40 |
| temperature | | | | | |
| (° C.) | | | | | |
| Transester- | 86.38 | 90.31 | 91.26 | 90.05 | 89.51 |
| ification | | | | | |
| conversion | | | | | |
| (%) | | | | | |

A conventionally mechanical agitating device was used to perform a batch transesterification reaction to serve as a comparison. Soybean oil of 2949 ml was mixed with methanol of 756 ml and KOH of 27 g in the mechanical agitating device. Test conditions and results are shown in Table 2.

TABLE 2
Test conditions and results

| Reaction time (min) | Transesterification conversion (%) |
|---|---|
| 0 | 0 |
| 3 | 75.3 |
| 6 | 81.4 |
| 9 | 82.6 |
| 12 | 83.2 |
| 60 | 85.6 |

Results in Table 1 show that transesterification conversion in accordance with the present invention being at least 86.38%, while transesterification reaction was continuously performed.

Results in Table 2 show that the conventional reactor only can achieve transesterification conversion of 85.6% even after a reaction time of an hour. Therefore, the present invention needs less reaction time and obtains higher transesterification conversion.

Various oils were modified in accordance with the present invention as another test of transesterification conversion. Test conditions and results are shown in Table 3.

TABLE 3
Test conditions and results

| | Example | | | | | |
|---|---|---|---|---|---|---|
| | 6 | 7 | 8 | 9 | 10 | 11 |
| Oil | Palm oil | Sunflower | Lard oil | Olive oil | Canola | Sesame |
| | | oil | | | oil | oil |
| Oil flow rate | 180 | 180 | 180 | 180 | 180 | 180 |
| (ml/min) | | | | | | |
| Methanol flow | 46 | 46 | 46 | 46 | 46 | 46 |
| rate (ml/min) | | | | | | |
| Alkali metal | KOH | KOH | KOH | KOH | KOH | KOH |
| compound | | | | | | |
| Alkali metal | 1.63 | 1.63 | 1.63 | 1.63 | 1.63 | 1.63 |
| compound | | | | | | |
| input rate | | | | | | |
| (g/min) | | | | | | |
| Filler | Stainless | Stainless | Stainless | Stainless | Stainless | Stainless |
| | steel wire | steel wire | steel wire | steel wire | steel wire | steel wire |
| Rotating speed | 900 | 900 | 900 | 900 | 900 | 900 |
| (rpm) | | | | | | |
| Reaction | 40 | 40 | 40 | 40 | 40 | 40 |
| temperature | | | | | | |
| (° C.) | | | | | | |
| Transesterification | 86.45 | 89.17 | 85.24 | 81.43 | 81.71 | 80.10 |
| conversion (%) | | | | | | |

The results in Table 3 show that transesterification conversions of various oils in accordance with the present invention are higher than 80%. Thus various oils can be effectively modified.

Various fillers were used in accordance with the present invention as another test of transesterification conversion. Test conditions and results are shown in Table 4.

TABLE 4
Test conditions and results

| | Example | |
|---|---|---|
| | 12 | 13 |
| Oil | Soybean oil | Soybean oil |
| Oil flow rate (ml/min) | 180 | 180 |
| Methanol flow rate (ml/min) | 46 | 46 |
| Alkali metal compound | KOH | KOH |
| Alkali metal compound input | 1.63 | 1.63 |
| rate (g/min) | | |
| Filler | Calcium oxide | Potash feldspar |
| Rotating speed (rpm) | 900 | 900 |
| Reaction temperature (° C.) | 40 | 40 |
| Transesterification conversion (%) | 93.51 | 93.10 |

Introducing reaction gas was used in accordance with the present invention as another test of transesterification conversion. Test conditions and results are shown in Table 5.

TABLE 5
Test conditions and results

| | Example | |
|---|---|---|
| | 14 | 15 |
| Oil | Soybean oil | Soybean oil |
| Oil flow rate (ml/min) | 180 | 180 |
| Methanol flow rate (ml/min) | 129 | 129 |
| Alkali metal compound | KOH | KOH |
| Alkali metal compound input | 1.63 | 1.63 |
| rate (g/min) | | |
| Filler | Stainless steel wire | Stainless steel wire |
| Reaction gas | None | Ozone |
| Rotating speed (rpm) | 900 | 900 |
| Reaction temperature (° C.) | 40 | 40 |
| Transesterification | 91.83 | 94.17 |
| conversion (%) | | |

Kulkarni et al. (2006) reported that transesterification conversions with adding ethanol, propanol, isopropanol and butanol are only 31-65% of that with adding methanol by using a conventionally mechanical agitating device. Accordingly, transesterification conversions in accordance with the present invention with adding ethanol, propanol, isopropanol and butanol are considered 25-61%.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A method of increasing transesterification conversion of oils comprising steps of:
packing a filler, the filler being packed into a rotating packed bed reactor comprising
a container having
an upper side;
a lower side;
a peripheral wall;
an oil feed being formed in the upper side of container;
a gas inlet being formed in the peripheral wall of the container; and
an oil outlet being formed in the lower side of the container; and
a rotary bed being mounted rotatably and powered to rotate in the container and having
an inner wall allowing passage of oils; and
a packed reaction region being formed along the radial direction of the rotary bed and packed with the filler;
centrifugally rotating, the rotary bed being driven to rotate relative to the container by an rotary driver;
injecting an oil, the oil and an additive being injected into the rotary bed through the oil feed;
transesterification, the centrifugal rotating of the rotary bed forcing the oil and the additive to pass through the filler in the packed reaction region and perform transesterification reaction; and
collecting, the oil and the additive passing through the filler in the packed reaction region and then being collected at the oil outlet.

2. The method of increasing transesterification conversion of oils as claimed in claim 1, wherein the oil is animal oil, vegetable oil, organic acid or a mixture thereof.

3. The method of increasing transesterification conversion of oils as claimed in claim 2, wherein the animal oil and the vegetable oil are a substance having triglyceride.

4. The method of increasing transesterification conversion of oils as claimed in claim 3, wherein the substance having triglyceride is selected from the group consisting of tung oil, peanut oil, cottonseed oil, rapeseed oil, Chinese tallow tree seed oil, tea oil, soybean oil, sesame oil, ricinus oil, corn oil, rice bran oil, palm oil, coconut oil, kardiseed oil, beef tallow oil, lard oil and sunflower oil.

5. The method of increasing transesterification conversion of oils as claimed in claim 2, wherein the organic acid comprises a hydrocarbon having carboxyl group.

6. The method of increasing transesterification conversion of oils as claimed in claim 5, wherein the hydrocarbon having carboxyl group is oleic acid.

7. The method of increasing transesterification conversion of oils as claimed in claim 1, wherein the filler is stainless, alkaline-earth metal compound, alumina, resin, zeolites, silicone or active carbon.

8. The method of increasing transesterification conversion of oils as claimed in claim 1, wherein the additive is alcohol, alkali metal compound, lipase or inorganic acid.

9. The method of increasing transesterification conversion of oils as claimed in claim 8, wherein the alkali metal compound is sodium hydroxide, potassium hydroxide or sodium methoxide.

10. The method of increasing transesterification conversion of oils as claimed in claim 8, wherein the inorganic acid is sulfuric acid, nitric acid or phosphoric acid.

11. The method of increasing transesterification conversion of oils as claimed in claim 8, wherein the alcohol is methanol, ethanol, propanol, isopropanol or butanol.

12. The method of increasing transesterification conversion of oils as claimed in claim 1, wherein a reaction gas is added to the rotating packed bed reactor through the gas inlet in the step of transesterification.

13. The method of increasing transesterification conversion of oils as claimed in claim 12, wherein the reaction gas is ozone.
